(19) United States
(12) Patent Application Publication
(10) Pub. No.: US 2004/0035028 A1
(43) Pub. Date: Feb. 26, 2004

(54) License plate and sticker protection device for new vehicles

(76) Inventor: Earl Thomas Beasley, Greensboro, NC (US)

Correspondence Address: Earl Thomas Beasley, 1507-A Hudgins Drive, Greensboro, NC, 27406, US

(21) Appl. No.: 10/140,510

(22) Filed: Jul. 23, 2002

(51) Int. Cl. G09F 7/00

(52) U.S. Cl. 40/202; 40/209

(57) ABSTRACT

The License Plate and Sticker Protection Device is designed to prevent tampering/theft of the vehicle license plate and sticker. This invention is being filed in the United States Patent and trademark Office as a non provisional utility patent application. Further disclosure of this invention has been submitted to a major automotive industrial company with the proper disclosure waiver in effect.

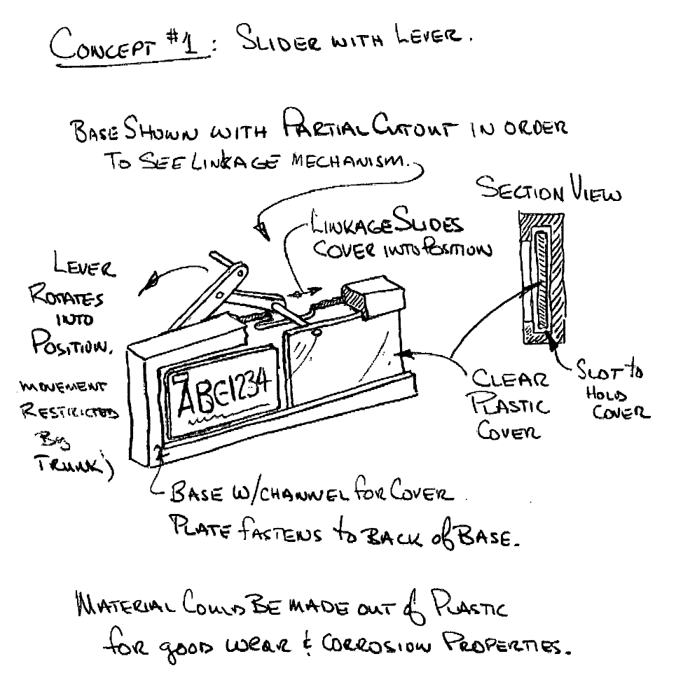

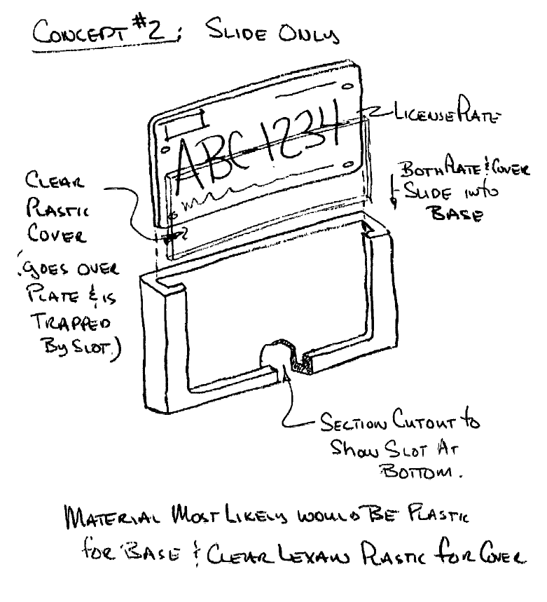

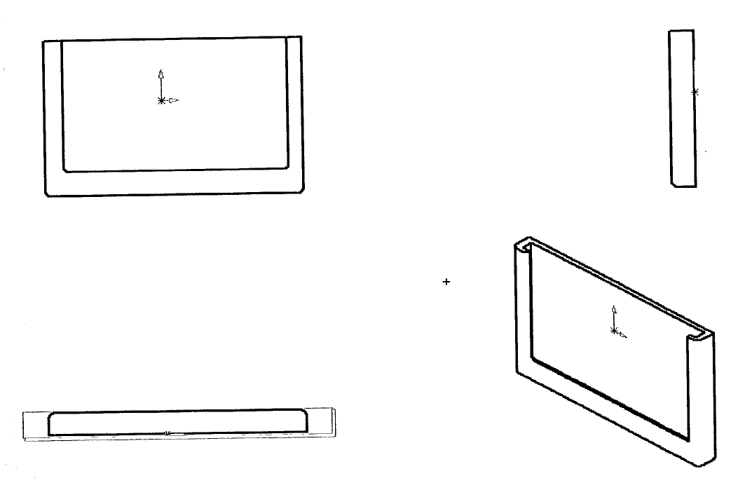

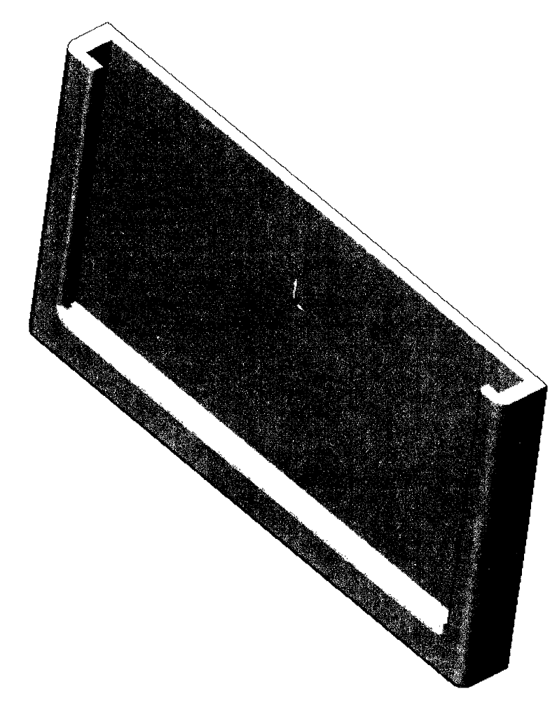

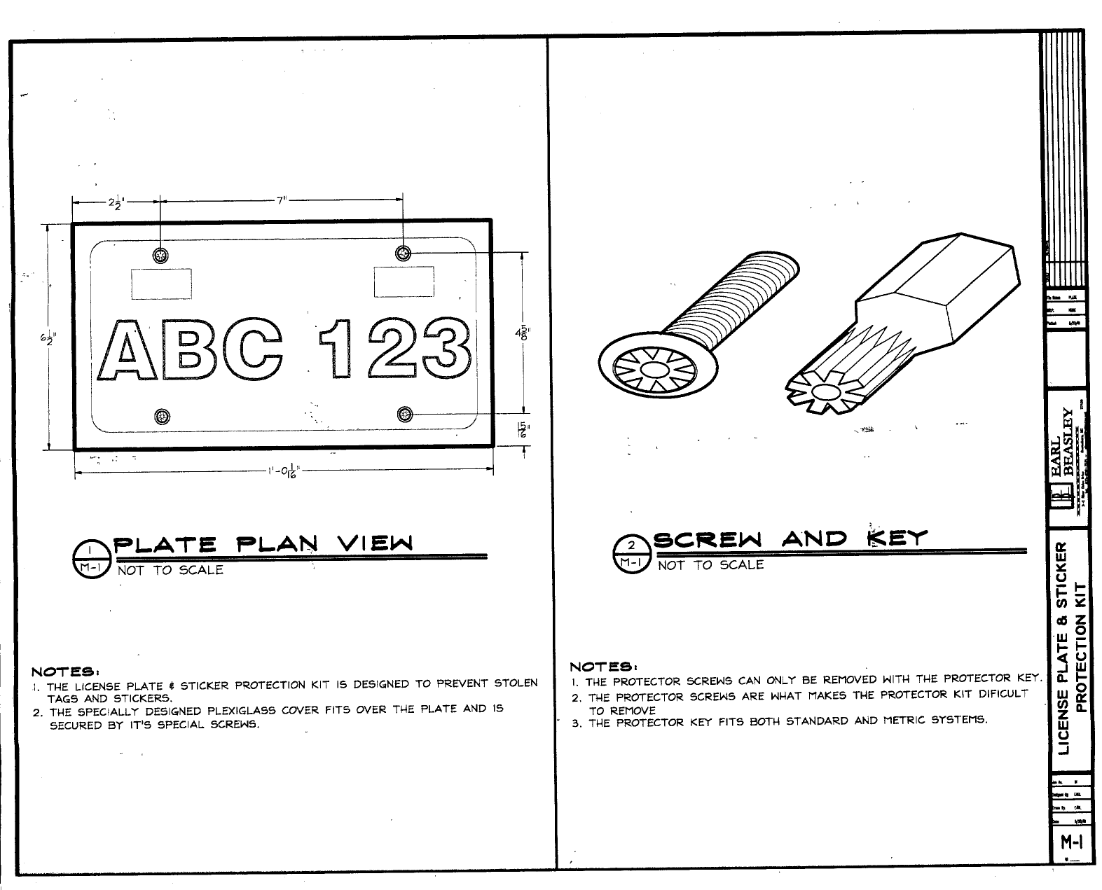

There is also a Power of Attorney on file in the Richmond County Clerk's Office in Rockingham, N.C. This Power of Attorney names my mother, Reverend Ruth M. Beasley-McSween, as P.O.A. to act on my behalf as needed in all matters pertaining to this invention.

This invention is a new and exciting one for the automotive industry and the consumer, because there is no evidence that any other such device exists.

### PROBLEM

There is a need to protect vehicle license plates and their registration stickers from tampering and theft. These stolen plates and stickers are used illegally on other vehicles not properly registered with the state. Consequently, the loss of the plates from the original vehicle is not noticed until the owner is stopped by authorities and is either ticketed or towed. This goes without saying that it is a major inconvenience for the driver not to mention the cost and time spent for replacement. Another possibility is the potential innocent involvement and liability presented to the owner of the officially registered vehicle. There is a need to protect the rightful owner of the license plates by a secure, easy, and efficient method.

### OBJECTIVE

The objective of this document is to describe and define several license plate protection concepts that will provide solutions to the above problem. The ideas are developed with the intent to provide original vehicle manufacturers with the technique by these ideas to better protect vehicle plates. These ideas are flexible enough to be offered as an aftermarket equipment addition to any vehicle in need. It is important to note, that these concepts shown here are only to provide a better description of the idea itself and not a specific solution. However, the ideas presented here have all rights reserved by the inventor and are not to be used in any way without the express written approval of the same inventor.

### SCOPE

The scope of this proposal is directed toward original equipment manufacturers (OEM) and the direct protection of license plates on new vehicles. The proposal also covers concepts that may be of use on aftermarket vehicles and vehicles manufactured prior to this implementation.

### CONCEPT DETAILS

There are primarily two concepts or ideas that can solve the above problem. These are examples of a technique to provide protection but are not considered the only ones. Should this idea spark interest, then a more detailed and total design concept evaluation, including manufacturing and assembly feasibility study be made.

The two ideas presented are:

1. Slider with lever concept—This is a sliding clear plastic plate that, when in position, covers the plate entirely. A lever located inside the trunk of a vehicle activates it. At the operator's discretion (Or anyone who has permission by access of the trunk keys), this lever is activated to protect the plate or adjust, modify, or remove the plate themselves. This idea is not limited to vehicles with trunks only as the concept can have a lockable position with its own locking device such as a key lock.

2. Slide only concept—This is a U-shaped channel with the opening at the top so that the plate can easily slide into position. The trunk door acts as a lock by covering the opening upon closing.

The following pages provide sketches and CAD drawings of these concepts.

1. What I claim as my invention is License Plate and Sticker Protection Device. This invention as stated above in two concepts for use on new vehicles, and installed by the original equipment manufacturer. Another element of the invention is also filed and is designed for installation by the vehicle owner or his or her designee. This is prepared in a kit to be sold by auto parts/other stores.
The claims on the two concepts are as follows:
Concept No. 1
This consists of a sliding clear plastic plate called a slider with lever. This plate will be installed so as to cover the license plate and sticker when the lever, which will be installed inside the trunk, is activated. The clear plastic plate has a locking device that when the license plate and sticker is covered will lock in place.
This device will prevent the vehicle plate and registration from being tampered with or stolen. Anyone without access to the owner's trunk key would be unable to activate the lever or easily remove the plate.
The lever may at the manufacturer's option be installed inside the vehicle and operated by the owner or operator by a button or lever much like the device that allows for the unlocking of the trunk or hood on existing vehicles.
Concept No. 2
This device is a u-shaped channel with the opening at the top so that the plastic could easily slide down and into the locking position over the license plate and registration. This device would be installed by the original equipment manufacturer.
The trunk door/lid itself would act as the locking device on this concept by covering the opening of the channel when the trunk is closed. Vehicles without trunks would use this concept with a key-lock device that the owner would lock into place as desired.
The self-installing kit-concept called License Plate Protection and Sticker Device Kit is for use on after market vehicles. This is a specially designed Plexiglas cover that fits over the license plate and is secured by special screws. These screws are designed to fit the tag for a particular vehicle. The screws cannot be removed easily by any screwdriver or other screw removal device since each device has its only key that removes the screws.
The screws are set in a recess fashion on the plate, which is an added protection.
